(19) United States
(12) Patent Application Publication
(10) Pub. No.: US 2019/0287122 A9
(43) Pub. Date: Sep. 19, 2019

(54) REAL-TIME SURVEY AND SCOREBOARD SYSTEMS

(71) Applicant: Benbria Corporation, Ottawa (CA)

(72) Inventors: Ying Du, Ottawa (CA); Ronald Richardson, Kanata (CA)

(73) Assignee: Benbria Corporation, Ottawa (CA)

(21) Appl. No.: 14/206,673

(22) Filed: Mar. 12, 2014

Related U.S. Application Data
(60) Provisional application No. 61/791,908, filed on Mar. 15, 2013.

(51) Int. Cl. G06Q 30/02

(52) U.S. Cl. CPC G06Q 30/0203

(57) ABSTRACT

What is disclosed is a system to enable real-time engagement with one or more customers utilizing one or more customer devices, implemented using one or more servers, said servers connected to said customer devices over at least one network, comprising: a survey phase, wherein one of the one or more customers utilizes the one or more customer devices to send feedback to one of the one or more servers over the at least one network; a post-survey phase, wherein the one of the one or more customers utilizes the one or more customer devices to send feedback to one of the one or more servers over the one or more networks; and a closure phase.

### CROSS REFERENCE TO RELATED APPLICATIONS

This application claims the benefit of U.S. Provisional Application No. 61/791,908, filed Mar. 15, 2013 which is hereby incorporated by reference herein in its entirety.

### FIELD OF THE INVENTION

The present disclosure relates to systems to engage with customers in real-time.

### BRIEF SUMMARY

In accordance with one embodiment, a system to enable real-time engagement with one or more customers utilizing one or more customer devices, implemented using one or more servers, said servers connected to said customer devices over at least one network, comprising: a survey phase, wherein one of the one or more customers utilizes the one or more customer devices to send feedback to one of the one or more servers over the at least one network; a post-survey phase, wherein the one of the one or more customers utilizes the one or more customer devices to send feedback to one of the one or more servers over the one or more networks; and a closure phase.

In one embodiment, the system comprises one or more internal systems, said one or more internal systems further comprising one or more employee devices, said employee devices coupled to each other, the one or more servers and one or more customer devices over the one or more networks, and. one or more display units.

In one embodiment, the system further comprises updating information on at least one of the one or more display units based on at least one of the received survey and post-survey feedback.

In accordance with another embodiment, a method to enable real-time engagement with one or more customers utilizing one or more devices, implemented using one or more servers, said servers connected to said devices over at least one network, said method comprising: performing a survey phase comprising receiving submitted feedback from one of the one or more customers, said feedback submitted by the one of the one or more customers using the one or more customer devices; performing a post-survey phase comprising receiving submitted feedback from one of the one or more customers submitted using the one or more customer devices; and performing a closure phase.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows enterprise system 100.

FIG. 2 shows an example of a multiple server implementation of server(s) 105.

FIG. 3 shows the phases of the real-time customer engagement process.

FIG. 3A shows an example flow chart of one embodiment for implementation of the survey, post-survey, and closure phases of the real-time customer engagement.

FIG. 3B shows a sample work flow for the real-time customer engagement process.

FIG. 4 shows an example of a survey page.

FIG. 5 shows a flowchart detailing the operation of one embodiment of the survey page(s) which uses visual question selection.

FIG. 6 shows user interface (UI) 600.

FIG. 7 shows user interface 700.

FIG. 8 shows user interface 800.

FIG. 9 shows user interface 900.

FIG. 10 shows an example of a scoreboard which has been updated in real-time.

FIGS. 11A and 11B show an example of a flow of customer engagement within the context of a loop.

FIG. 12 shows a Mass Notification System (MNS) for an employee to notify other employees and customers.

FIG. 13 shows an Intelligent Enterprise Notification System (IENS) for an employee to notify other employees and customers.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

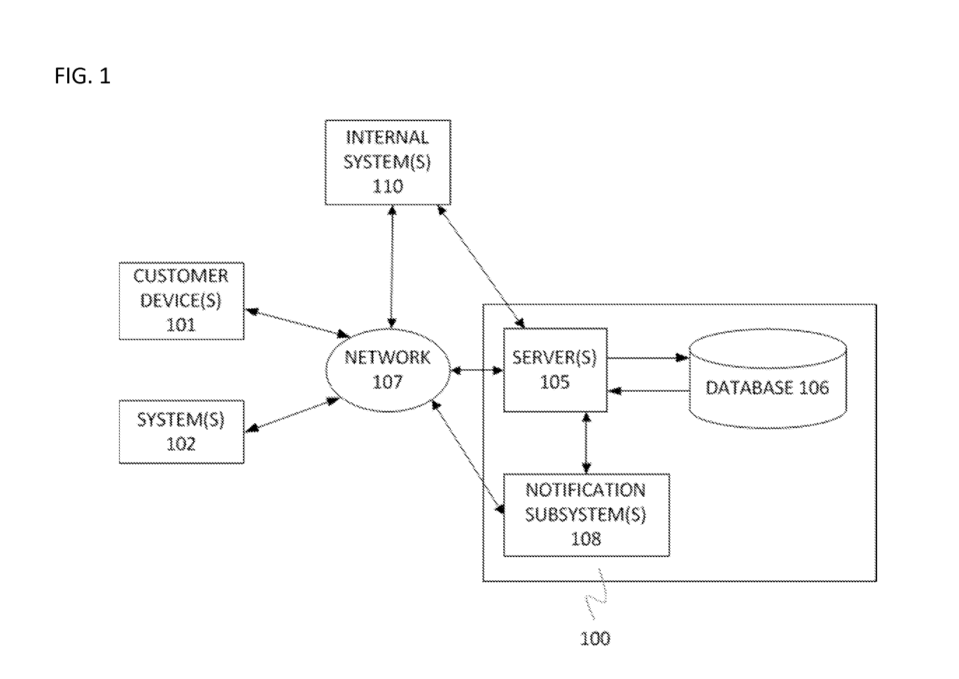

FIG. 1 shows an example architecture to implement the system and method which is the subject of this specification. Enterprise system 100 comprises server(s) 105, database 106 and notification subsystem(s) 108, and may be operated and supervised by one or more administrators. Server(s) 105 are operational to, for example: Receive data from customer device(s) 101, system(s) 102, and internal system(s) 110; perform processing of data received from customer device(s) 101, system(s) 102, and internal system(s) 110; retrieve data from database 106 to assist or enable this processing; generates data and commands to, for example, enable operations at customer device(s) 101, system(s) 102 and internal system(s) 110; and transmits said data and commands to customer device(s) 101, system(s) 102 and internal system(s) 110.

In one embodiment, server(s) 105 communicates with customer device(s) 101, system(s) 102 and internal system(s) 110 using network 107. Network 107 is, for example, an internal network or an external network, telephone network, local area network (LAN), wide area network (WAN), campus or corporate area network (CAN), metropolitan area network (MAN), virtual private network (VPN), personal area network, mesh network, the Internet, or wireless network. Network 107 may comprise a plurality of subnetworks.

Customer device(s) 101 can refer to one or more customer devices, for example, laptops, desktops, mobile phones, IP phones, smartphones, phones, tablets or in-store kiosks or other customer devices such as telephones to enable a customer to interact with enterprise system 100. In a further embodiment, the in-store kiosk can be, for example a tablet computer stationed in an area of the store. Methods to enable the use of a tablet computer as a kiosk are described in, for example, “Kiosk App,” located at http://store.griffintechnology.com/kiosk-app, retrieved Mar. 14, 2013 and herein incorporated by reference as if reproduced in its entirety.

In one embodiment, enterprise system 100 may be used to serve a single organization with customers, such as a corporation or business. In another embodiment, enterprise system 100 may be used to provide a Software as a Service (SaaS) offering to one or more organizations such as franchises, businesses or corporations. A particular organization may use a sub-system which is part of system(s) 102, which communicates with enterprise system 100 via network 107.

In another embodiment, enterprise system 100 may be used to serve a single organization such as a corporation or business, but wherein the business or corporation has several divisions or departments, each having different sets of customers.

Database 106 stores relevant data to enable operation of the enterprise system 100. In the embodiment where enterprise system 100 is used by an organization, database 106 may, for example, store data related to each customer of the organization. Each set of data related to each customer of the organization must be kept separate from the data relating to the other customers. In the embodiment where the organization has several different brands, or divisions or departments, it may be necessary to partition the database so that data related to each division or department is separate from the other divisions or departments. Then, within each partition, each customer of that division or department may have accounts or other data which must be kept separate from the data of the other customers of that division or department. Then the partition must be further divided into smaller sub-partitions to ensure that the data is kept separate.

In one embodiment, the enterprise system 100 belongs to a hosted service provider providing the service on behalf of one or more businesses or corporations. Each of these businesses or corporations may have their own customers. Then database 106 stores data to serve a plurality of businesses or corporations. In one embodiment, the database 106 must be partitioned so that data relating to each business or corporation is kept separate from data relating to other businesses or corporations. Furthermore, for each business, each customer of that business may have accounts or other data which must be kept separate from the data/accounts of the other customers of that business. Then the partitions must be divided into smaller sub-partitions to ensure separation of data.

In a further embodiment, a hosted service provider may be serving a business with one or more brands or lines of business. Then within the partition for that business, there may be sub-partitions, each sub-partition corresponding to one of the one or more brands or lines of business. The data related to each brand or line of business is kept separate from the data related to the other brands or lines of business which are owned by the same business. In a further embodiment, each customer of a brand or line of business may have data such as an account which must be kept separate from the data of the other customers of that brand or that line of business. Then the sub-partitions must be divided into smaller sub-partitions to ensure separation of data. The database 106 can be divided into partitions of different granularity and size depending on the requirements of the enterprise system 100.

The server(s) 105 connect to notification subsystem(s) 108 to send notifications to customer devices 101, systems 102 or internal system(s) 110 via, for example, network 107 as necessary. These notifications may be sent via various methods, including email, phone calls, microblog update, and Short Message Service (SMS) as necessary. In one embodiment, the choice of media used to send the notifications depends on the settings that the customer has chosen. In the embodiment where the enterprise system 100 is run by a hosted service provider on behalf of one or more businesses or corporations, the administrators of the hosted service provider may work together with each business or corporation to configure the choice of media for the employees and customers of that business or corporation. In the embodiment where the enterprise system 100 is run by one organization with several divisions or departments, each division or department may choose different media depending on divisional or departmental requirements. In another embodiment, the administrators of the enterprise system 100 can also choose different notification media for each division, department, product line, employee group, customer, the entire business, or other groups of related people.

Internal system(s) 110 could be, for example, some part of the system such as that described in FIG. 1 of “System for Extracting User Feedback from a Microblog Site, assigned Ser. No. 13/458,527, filed Apr. 27, 2012 to Du et al and herein incorporated by reference as if reproduced in its entirety; or the implementation system detailed in the section titled “The Implementation System” in the US patent application “System And Method For Rule-Based Information Routing and Participation,” assigned Ser. No. 13/728,240, filed Dec. 27, 2012 to Richardson. Internal system(s) 110 can also comprise employee devices. In the case where enterprise system 100 is run by a hosted service provider on behalf of one or more businesses or organizations, internal system(s) 110 may comprise the internal system(s) of each business or organization.

In an embodiment, server(s) 105 communicate with internal system(s) 110 over an internal connection such as is shown in FIG. 1. In the case where enterprise system 100 is run by a hosted service provider on behalf of one or more businesses or organizations, communications between the internal system(s) of each business or organization are kept separate from the communications between the internal system(s) of other businesses or organizations.

Various embodiments or implementations of enterprise system 100 are possible. For example, in one embodiment, enterprise system 100 is implemented using a server or servers. In another embodiment, it is implemented as a cloud-based implementation. In other embodiments, it is implemented in software, hardware or a combination of software and hardware. Similarly, various embodiments of the components of enterprise system 100, that is, server(s) 105, database 106 and notification subsystem(s) 108 are also possible. In one embodiment, these components are implemented using a server or servers. In another embodiment, these components are implemented using a cloud-based implementation. In other embodiments, these components are implemented in software, hardware or a combination of software and hardware. In addition, various software technologies and programming languages can be used in these implementations, such as Node.js server, J2EE, .NET framework, NoSQL, SQL, Java, JavaScript, Python, Ruby, C, C++, C#, and PHP.

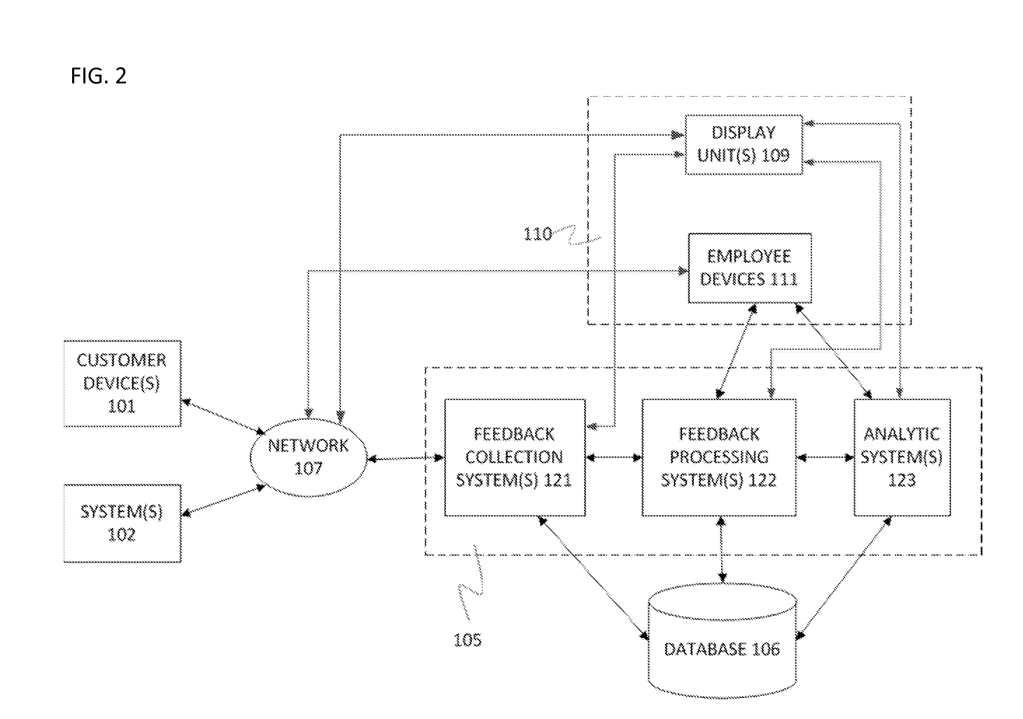

In yet another embodiment server(s) 105 are implemented using multiple servers, each of which is interconnected by, for example, an internal network. FIG. 2 shows such an example. In FIG. 2, feedback collection system(s) 121 operates to collect, for example, inputs sent by customer device(s) 101 and system(s) 102. These could be, for example, survey results, post-survey interactions, login data, customer comments and questions, and other information sent by customers. Such data is stored by feedback collection system 121 in database 106. Feedback collection system(s) 121 also sends information to feedback processing system 122 for further processing. In addition, feedback collection system 121 transmits data to customer device(s) 101 and system(s) 102, such as data to generate user interfaces (UI), survey data, post survey interactions, and other such information. In one embodiment, feedback collection system 121 comprises an application or app server. The app server performs different tasks, such as handling all Hyper Text Transfer Protocol (HTTP) requests originating from a customer device. The app server may be, for example, implemented using multiple processing units, where multiple processes run simultaneously. In a further embodiment, there is a load balancer which distributes the workload evenly between the multiple processing units. In another embodiment, multiple servers are setup in a cluster to allow high availability and failover support. In one embodiment, multiple clusters are setup to allow for multi-region support and disaster recovery. In yet another embodiment, multiple clusters are setup to provide redundancy. In another embodiment, the feedback collection system comprises a WebSocket server. If a browser on a customer device(s) 101 attempts to communicate with the feedback collection system(s) 121 using the WebSocket protocol, the communication and subsequent interaction is handled by the WebSocket server. In yet another embodiment, partial or full UI contents are served through WebSocket connections to customer devices.

Feedback processing system(s) 122 interacts with feedback collection system(s) 121, analytic system(s) 123, database 106 and employee device(s) 111 so as to perform processing of data. Feedback processing system(s) 122 may perform various tasks including generation of surveys, selection of survey questions tailored to various criteria, facilitating post survey interactions, processing of customer comments and questions, processing of employee comments and questions, management of workflows and so on.

Analytic system(s) 123 interact with feedback processing system(s) 122, employee device(s) 111 and database 106, to perform more detailed analytical calculations, such as statistical analysis of survey results. Other examples of analysis provided by analytic system(s) 123 may include time-based, customer-based, location-based, business-unit-based or sector-based analysis so as to identify trends and correlate events to enable businesses and organizations to gain a better understanding of their operations and environment, and therefore function and perform better.

Employee devices 111 are part of internal system(s) 110. These can be, for example smartphones, tablets, laptops, desktops and other devices which are used by an employee. Employee devices 111 may be connected to feedback processing system(s) 122 and analytic system(s) 123 via internal network connections. They may also be connected to network 107. In the case where enterprise system 100 is run by a hosted service provider on behalf of one or more businesses or organizations, employee devices 111 are the devices owned by the employees of the one or more businesses or organizations. In one embodiment, employee devices 111 also include devices owned by the administrators of enterprise system 100. Employees can interact with the analytic system(s) 123 and feedback processing system(s) 122 in a variety of ways. For example, employees may instruct analytic system(s) 123 through employee devices 111 to perform the analyses outlined above to gain better understanding of their businesses or organizations.

In another embodiment, display unit(s) 109 are part of internal system(s) 110. Data from server 105; or specifically from feedback collection system 121, feedback processing system 122 and analytic system 123 is transmitted to display unit(s) 109 either through an internal connection, or through network 107. The display unit(s) 109 may be, for example, monitors in the kitchen area of a restaurant, monitors in offices of managers in a car wash or in a hotel manager's office, or monitors in regional headquarters of a corporation. In another embodiment, the display unit(s) 109 can be a combination of a device such as an Apple® iPod®, or laptop, or desktop, or tablet, or smartphone; with a monitor.

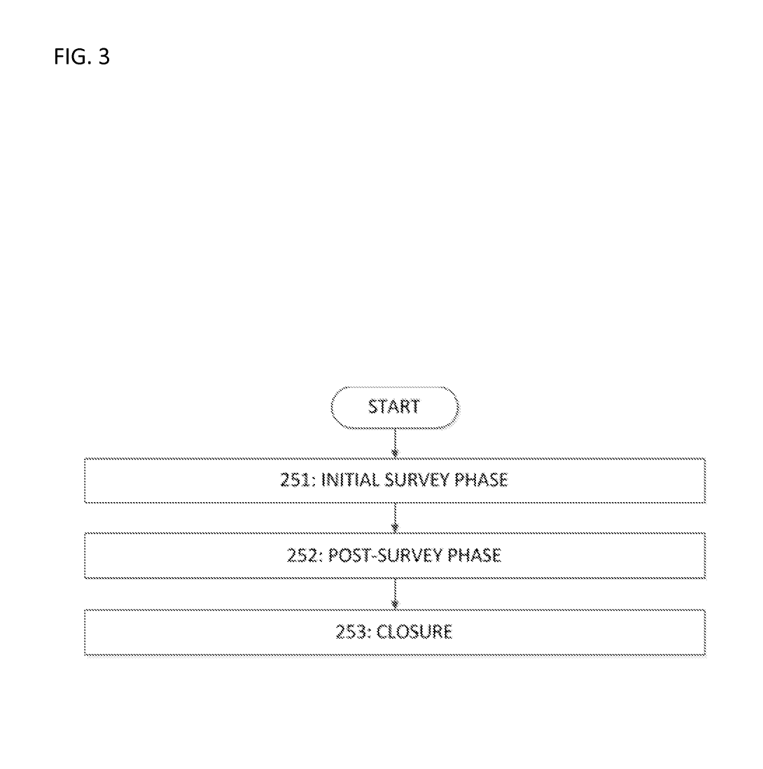

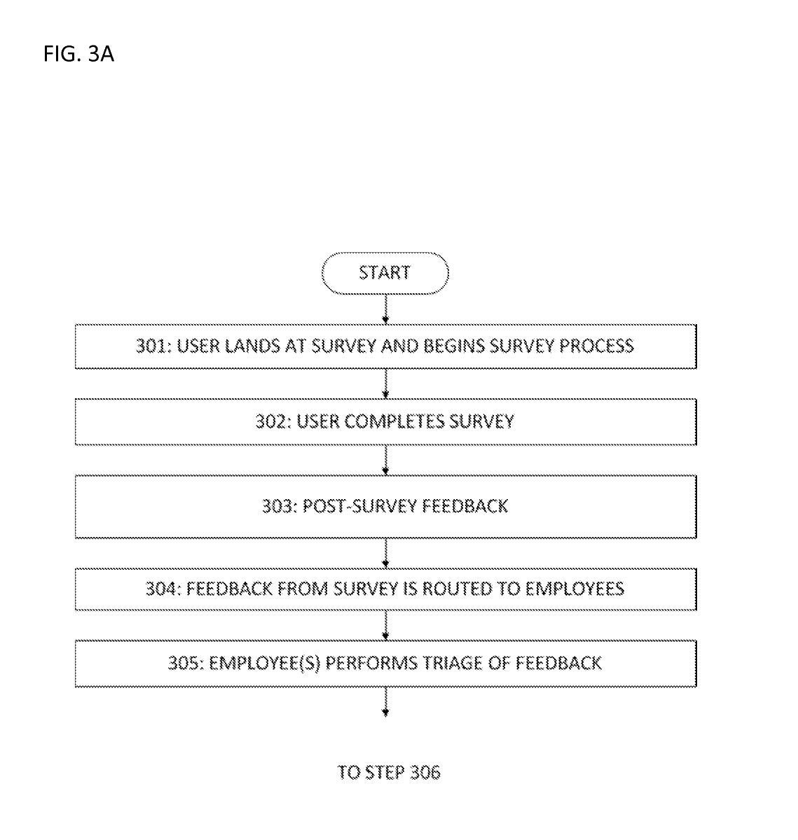

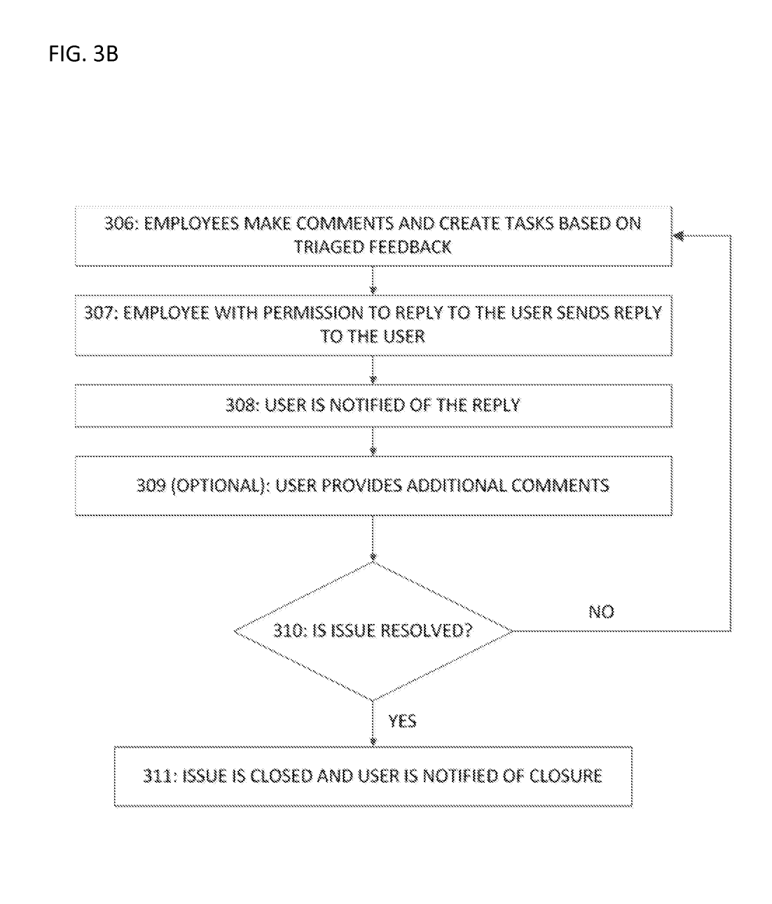

FIGS. 3, 3A and 3B respectively show the phases of the engagement process; an example flow of the engagement process; and sample customer workflow for the engagement process that is the subject of this specification. The phases of the engagement process; and such an example flow is managed, for example, by server(s) 105 of enterprise system 100 in FIG. 1 or specifically by feedback processing system(s) 122 of FIG. 2. The customer and employee interactions shown in FIG. 3A are carried out, for example, using customer device(s) 101, system(s) 102 and employee devices 111 as shown in FIG. 2. As mentioned previously, the engagement process may be implemented by a business or organization, or by a hosted service provider on behalf of one or more businesses or organizations.

In one embodiment, the engagement process is shown in FIG. 3, comprising an initial survey phase (step 251) or more simply, the survey phase, followed by a post-survey phase (step 252) followed by a final closure phase (step 253). The post-survey phase contains post-survey feedback, routing, triaging, and customer workflow. Depending on the feedback supplied during the initial survey and post-survey feedback, and the output of the routing and triaging, the customer workflow is configured appropriately.

A further embodiment is shown in FIGS. 3A and 3B. In FIG. 3A, steps 301 and 302 describe the survey phase 251 of FIG. 3. In one embodiment, step 301 is implemented using an online survey. In this embodiment, the customer lands at the survey using, for example, an application or browser at customer device(s) 101, and begins the survey process. The customer may land at the survey by, for example, typing in a URL, touching a screen at an in-store kiosk, or by scanning in a QR code. In one embodiment the survey comprises a welcome page, one or more survey pages and a summary page. When the customer first lands at the survey, the welcome page is presented on the screen. The welcome page performs the function of helping ease customers into the survey. In one embodiment, the customer is invited to share the results of the survey on a social networking site, for example, Facebook® or Google® Plus® or Twitter®. In a further embodiment, the customer is invited to log in to these social networking sites by, for example, entering a username and password. Information such as the customer's contact information can be then retrieved via the social networking site. In one embodiment, the customer enters his or her contact information such as his email address and mobile phone number at the welcome page. The customer can move to the next page, which is the start of the survey page(s), by, for example, clicking or tapping on the welcome page.

In another embodiment, the welcome page disappears automatically, and advances to the survey page(s) when a customer is detected, for example, via touch input, or by face scanning through a camera in the device, or based on a pre-defined timer.

In one embodiment, there are no welcome pages. In another embodiment, there is no summary page.

In one embodiment, the survey page(s) comprises an interactive survey consisting of a plurality of interactions. Each interaction comprises an information section, one or more queries and one or more options to respond related to said queries. In addition, the survey page(s) also provide information on the customer who initiated the survey, and the person who will be submitting the survey. The person who will be submitting the survey may be different from the customer who initiated the survey. The person can submit the survey on behalf of another person who is deemed as the initiator of the survey. For example, a staff member can submit a survey on behalf of a customer.

A query could be, for example, a request or a prompt to enter a comment; a survey question; or an instruction. Options to respond to the query could be, for example, a list or drop down menu comprising a plurality of answers, a slider, a choice of colours, a choice of date and time, entering a comment, giving the customer a choice to upload a document or an image, picking location from a map and selecting a room number.

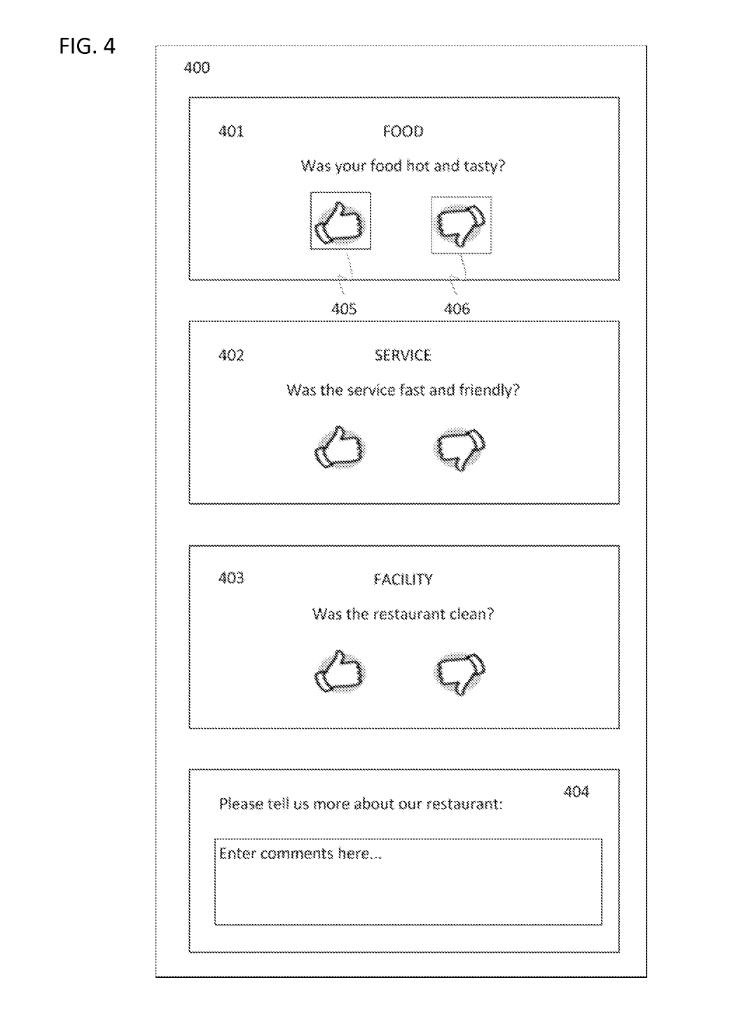

In one embodiment, multiple queries and options to respond to each query are shown on the screen of the customer device(s) 101 at the same time. In another embodiment, all queries and options to respond to each query are shown on the screen of the customer devices(s) 101 at the same time. An example page 400 is shown in FIG. 4. In one embodiment, the survey may comprise one or more categories, such as 401, 402 and 403 of survey page 400. For example, for the food category (401) a customer of the restaurant is presented with a query comprising the question “Was your food tasty?” and is presented with options to respond, comprising a thumbs up for a yes vote (405), and a thumbs down for a no vote (406). In a further embodiment, there may also be an extra field 404 to solicit customer comments. In yet another embodiment there can be multiple queries in each category.

In an embodiment where the survey comprises multiple pages, each page has queries, and options to respond to the queries, similar to survey page 400. In one embodiment, when a customer completes all the questions on one page of a multiple page survey such as survey page 400, the UI is refreshed with the next page of queries and options to respond to the queries.

In one embodiment, the interactive survey within the survey page(s) is implemented using visual question selection. A system and method for visual question selection is detailed in US patent application “Visual Question Selection,” assigned Ser. No. 13/791,956, filed Mar. 9, 2013 and herein incorporated by reference as if reproduced in its entirety.

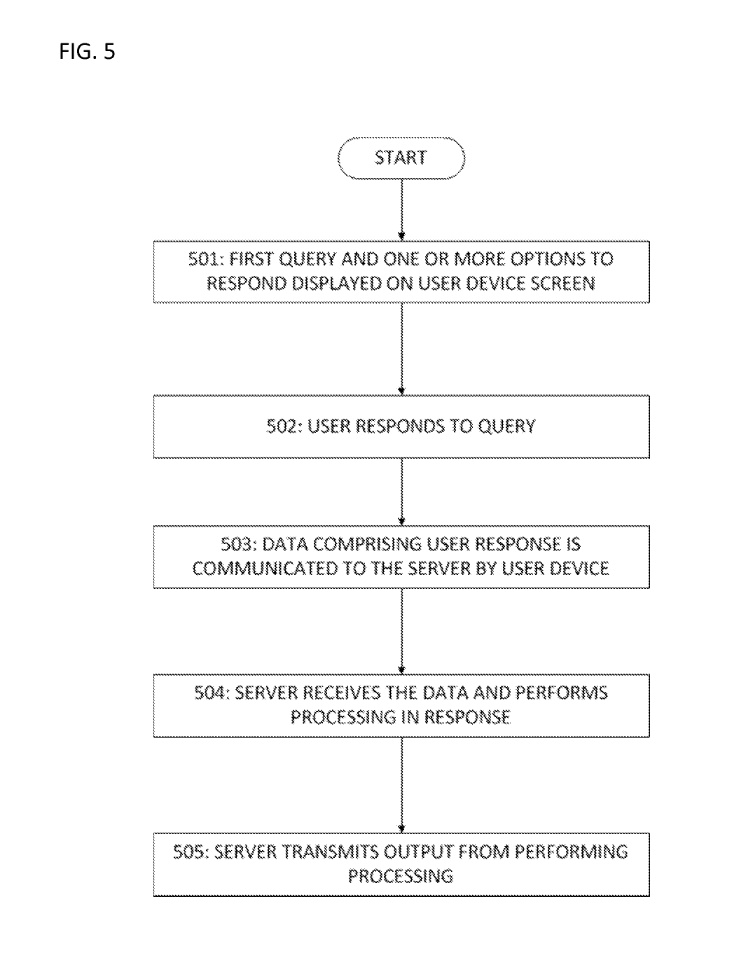

FIG. 5 shows a detailed flowchart which describes the operation of this system and method. While the description below refers to customer device(s) 101, the same description can be applied to system(s) 102.

In FIG. 5, the following is shown. In step 501, a first query and one or more options to respond to the first query, is retrieved by server(s) 105 from database 106 and transmitted to the customer device(s) 101. A query could be, for example, a request or a prompt to enter a comment; a survey question; or an instruction. Options to respond to the query could be, for example, a list or drop down menu comprising a plurality of answers, a slider, a choice of colours, a choice of date and time, entering a comment, and giving the customer a choice to upload a document, an image or other file. The first query and the one or more options to respond to the first query are displayed to the customer on the screen of customer device(s) 101. In one embodiment, the first query is a question, and the one or more options to respond to the first query is a first plurality of answers. In one embodiment, the first plurality of answers is displayed in interactive text or interactive graphic form. Examples of interactive graphic form include icons, “like” and “unlike” buttons. In one embodiment, the first query and the one or more options to respond to the first query are displayed at the customer device(s) 101 as part of a UI. The data and code describing the UI is generated by the server(s) 105, which then transmits the data and code to the customer device(s) 101 which renders the UI for the customer.

In step 502, the customer utilizes the customer device(s) 101 to respond to the query. For example, in the case where the one or more options to respond is a first plurality of answers, the customer responds to the first query by selecting a first answer from the first plurality of answers. This can be achieved by, for example, clicking, or touching the interactive text or interactive graphic on a touch screen, corresponding to the customer's desired answer.

In step 503, data comprising the customer response is communicated to the server(s) 105 by the customer device(s) 101.

In step 504, the server(s) 105 receives the data, and performs processing in response to receiving the data. During this processing, the server(s) 105 may retrieve data from database 106.

In step 505, the server(s) 105 transmits an output from performing the processing in step 204 to the customer device(s) 101. In one embodiment, the output comprises data and code to enable the display of at least the first query and the response to the first query.

Other forms of processing and transmitting of output are possible. In another embodiment, the operation to generate the display of at least the first query and the response to the first query in a new UI is performed at the “client-side,” that is by customer device(s) 101. In this embodiment, at least some of the data and code to enable the display of at least the first query and the first response is transmitted as part of the code sent by the server in step 501.

In a further embodiment, the processing performed in step 504 by server 105 comprises selecting a second query and one or more options to respond to the second query. This could be, for example, a second question and a second plurality of answers. In step 505, data comprising the second query and the one or more options to respond are transmitted by the server to the customer device 101. Then, the customer device 101 generates a new UI at the “client-side” comprising the first query, the response to the first query, the second query, and the one or more options to respond to the second query.

In a further embodiment, in step 504, the processing performed by server(s) 105 comprises generating a new UI comprising the first query, the first response, the second query and the one or more options to respond to the second query. For example, the new UI could comprise the first question, the selected first answer, the second question and a second plurality of answers corresponding to the second question. The server(s) 105 then transmits data in step 505 to enable display of the generated UI comprising the first query, the selected first option, the second query and the one or more options corresponding to the second query at the customer device(s) 101.

In another embodiment, in steps 504 and 505, the server performs processing and then transmits data and code to enable “refreshing” of the previous UI displayed on the customer device(s) 101. For example, if the one or more options to respond to the first query comprises a first plurality of answers, and the customer responds by selecting an answer, then in steps 504 and 505 the server performs processing and transmits data and code to the customer device so as to refresh the UI at the customer device.

In one embodiment, as part of the refreshing process, the unselected answers “disappear” from the UI, and the second question and the second plurality of answers to the customer device appear. Then, the refreshed UI comprises the first question, the selected first answer, the second question and the second plurality of answers.

In another embodiment, the refreshing process comprises merely appending the second question and the second plurality of answers to the customer device.

In yet another embodiment, at least some data and code to enable “refreshing” is transmitted as part of the code sent by the server in step 501. Then in step 504 the server selects a second query and one or more options to respond to the second query, and in step 505 this second query and corresponding one or more options is transmitted to the customer device. Then, the generation of the UI as part of the refresh operation is performed on the “client-side”.

In one embodiment, the customer device(s) 101 performs the following operations:

The first response is displayed on the UI;

Options to respond to the first query other than the selected response “disappears” from the UI;

The second query appears on the UI; and

The one or more options to respond to the second query also appear on the UI.

In another embodiment, the customer device(s) 101 simply appends the second query and the one or more options to respond to the second query to the first query and the options to respond to the first query.

In one embodiment, steps 502-505 are repeated multiple times. During each repetition, a query and one or more options to respond to the query are presented to the customer. The customer selects an option from the one or more options, and the selection is then transmitted to the server. Based on the selection, the server performs further processing, and transmits data to the customer device to enable the display of a UI comprising the queries and responses during each previous repetition; and a new query and one or more options to respond based on the further processing. At the final repetition, the server transmits data to enable the display of a UI comprising the queries and responses during each previous repetition, and a final query and options to respond to the final query.

In another embodiment, similar to as described above, at least some of the data and code to enable the display of at least previous queries and previous responses was transmitted as part of the code sent by the server in step 501. Then at each repetition, the server performs processing and sends data corresponding to a new query and one or more options to respond to the new query. The customer device(s) 101 then generates a new UI, or refreshes the previous UI at the client-side. In one embodiment, the new UI or the refreshed UI displays the queries and responses chosen during each previous repetition; and a new query, and one or more options to respond to the new query. In another embodiment, the new query and one or more options to respond to the new query are appended to the one or more existing queries and options to respond to the existing queries.

For example, there may be five repetitions in total, and in each repetition the query could be a question, and the one or more options for each repetition could be a plurality of answers. Referring to the example above, at the 5^{th} repetition, a UI is presented on the screen of customer device(s) 101 containing the first question and selected first answer; the second question and selected second answer, the third question and selected third answer; the fourth question and selected fourth answer; and finally a fifth question and a plurality of answers to respond to the fifth question.

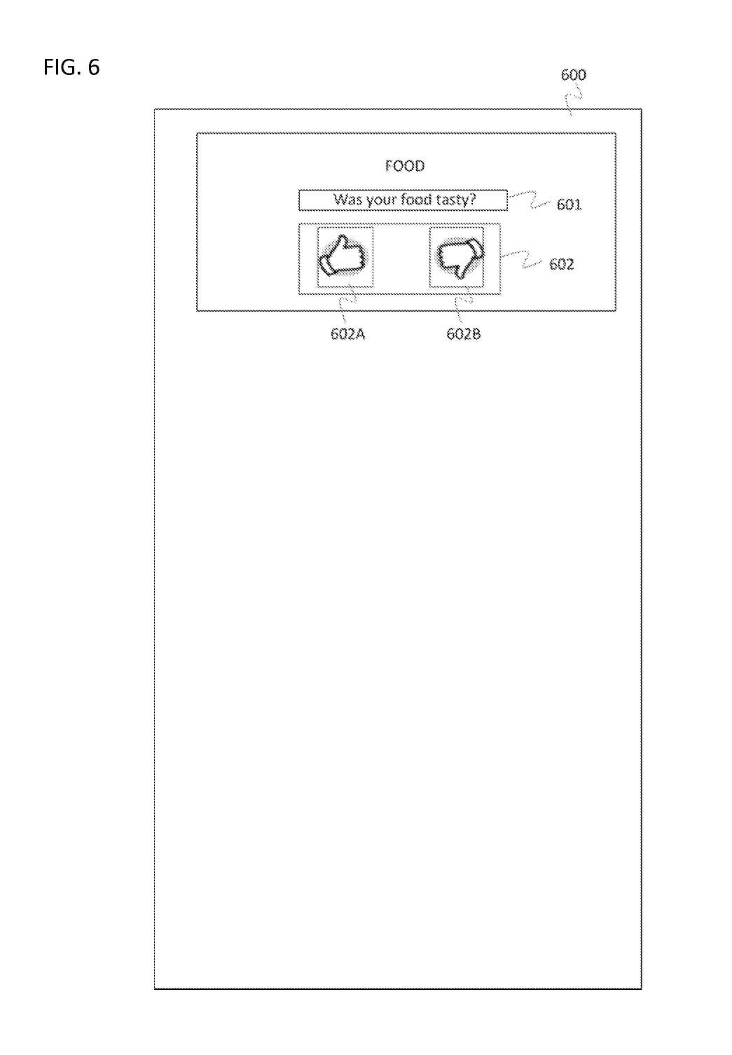

Another example is presented in FIGS. 6-9. FIG. 6 shows UI 600 seen by the customer at the start of the process. As previously explained, the server(s) 105 transmits data to enable the display of UI 600 at customer device(s) 101. UI 600 comprises query 601 which is the question “Was your food tasty;” and one or more options 602 containing options 602A (thumbs up icon) and 602B (thumbs down icon) to respond to query 601 is also shown.

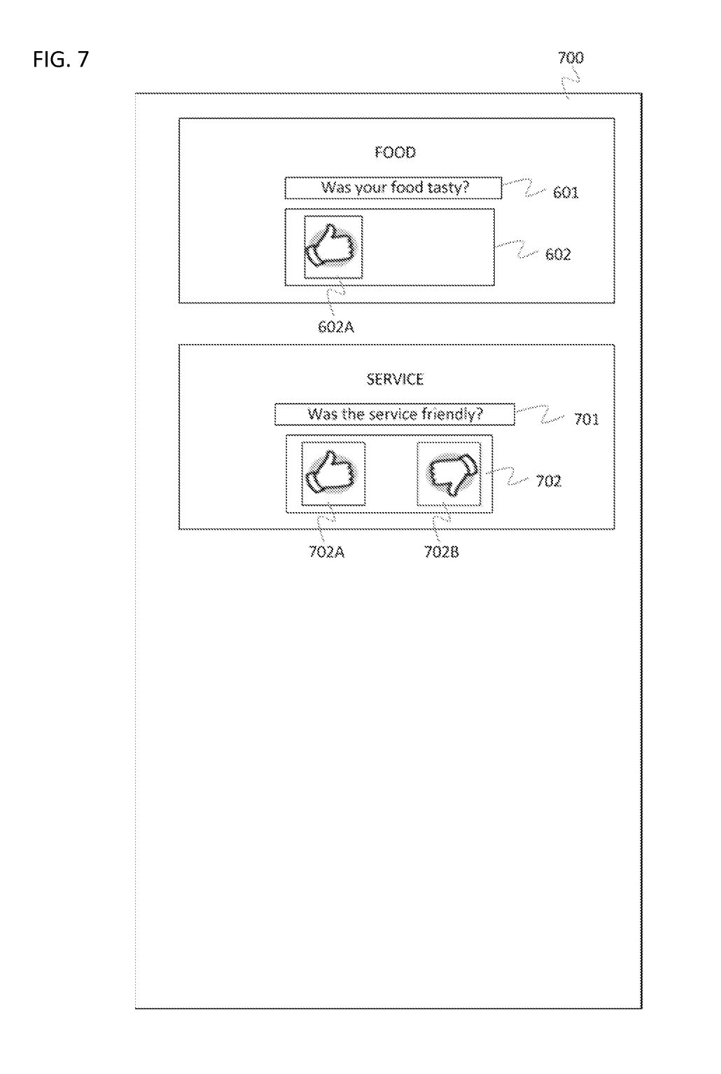

If the customer selects, for example, 602A, then UI 700 as shown in FIG. 7 is displayed on the screen of customer device(s) 101. Methods to create this display have been described above. UI 700 comprises query 601, a response comprising option 602A, query 701 “Was the service friendly” and options to respond 702 containing options 702A (thumbs up icon) and 702B (thumbs down icon).

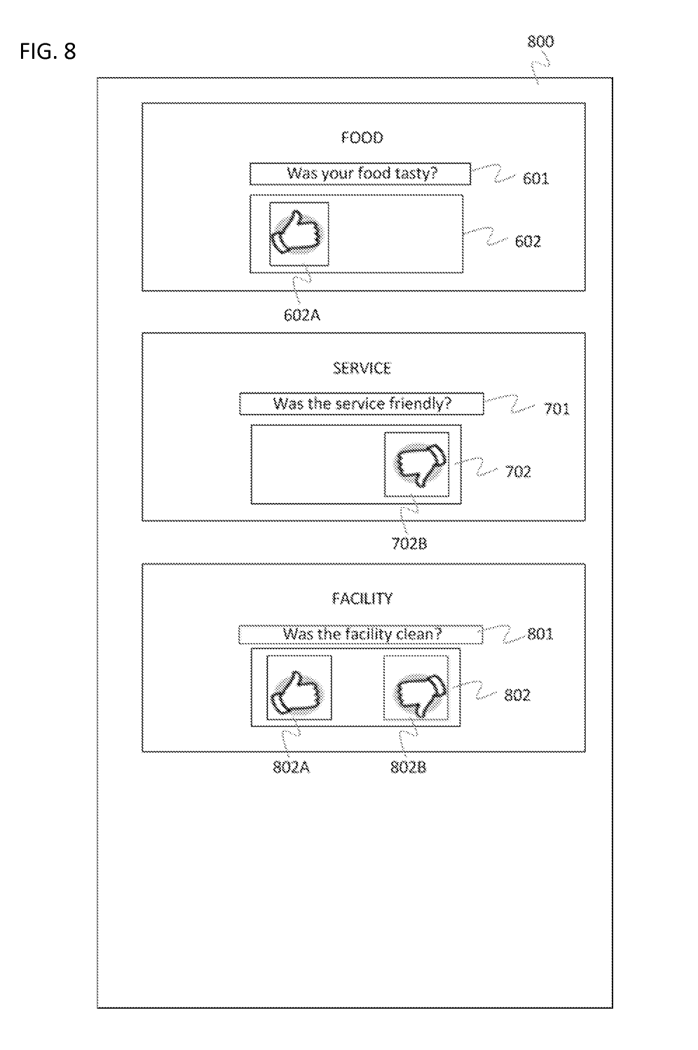

If the customer selects option 702B, then UI 800 as shown in FIG. 8 is displayed on the screen of customer device(s) 101. Methods to create this display have been described above. UI 700 comprises query 601, a response comprising option 602A, query 701, a response comprising option 702B, a query 801 “Was the facility clean?” and options to respond 802 containing options 802A (thumbs up icon) and 802B (thumbs down icon).

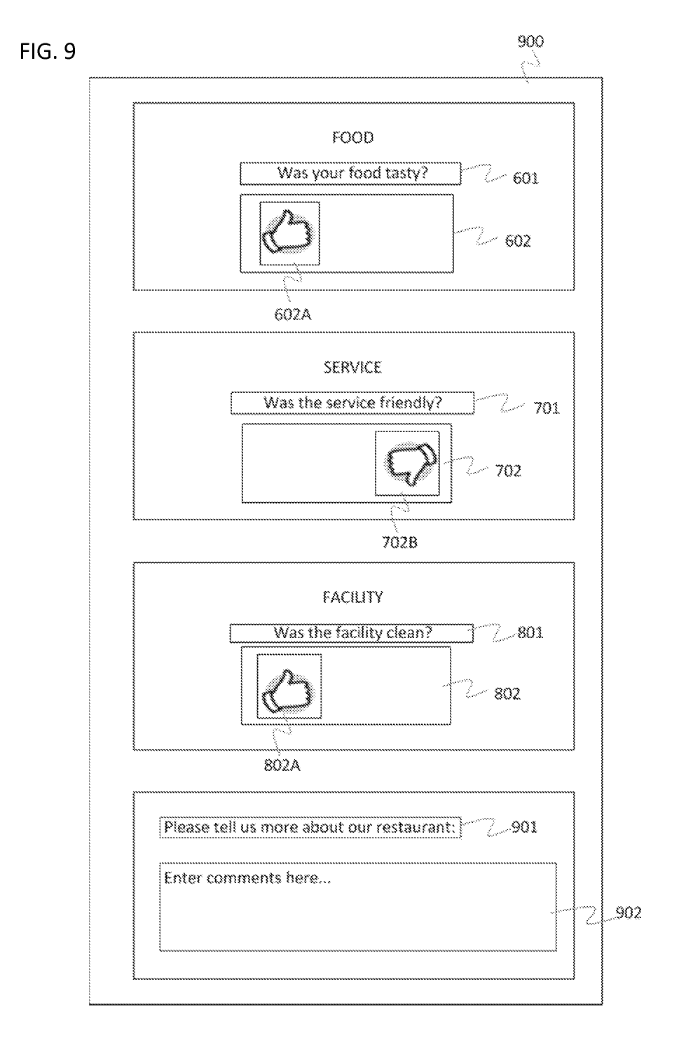

If the customer selects option 802A, then UI 900 as shown in FIG. 9 is displayed on the screen of customer device(s) 101. Methods to create this display have been described above. UI 900 comprises query 601, a response comprising option 602A, query 701, a response comprising option 702B, a query 801, a response comprising option 802A, a query 901 “Please tell us more about our restaurant:” and an empty field for comments 902.

In another embodiment, the number of remaining repetitions and the types of queries depend on the response during each repetition.

While “server-side” and “client-side” methods relating to generation or refreshing of the UI have been described above, implementation is not limited to only these methods. In a further embodiment, generating or refreshing of the UI is implemented using a combination of the “server-side” and “client-side” methods.

In another embodiment, the survey page(s) additionally comprise a query which allows the customer to select the location. In one embodiment, the location selection is a drop-down menu. In another embodiment, the predefined locations are sorted by their proximity to the customer's current location. In yet another embodiment, the customer is assisted in his or her location selection using a map view, Global Positioning Satellite (GPS) or other geo-location technology data.

In another embodiment, the survey page comprises an explicit submit button or submit link that a customer must click on to submit the survey. In another embodiment, the survey page is an “auto-submit” page, that is, upon completion of all required survey questions, a timer is displayed and it begins to count down. After the timer has elapsed, the results will be automatically submitted. In another embodiment, if the customer changes the answer to a question, the timer countdown is stopped and reset to its starting value.

In another embodiment, the survey page(s) is a “force complete” page(s), that is, a customer must answer all the queries in the survey to complete the survey page(s). In another embodiment, the survey page(s) is an “optional complete” page, that is the customer must answer at least one survey query or a comment must be added to submit the survey page(s). In yet another embodiment, each query can have the ‘optional’ or ‘required’ properties. Queries that have the ‘optional’ property can be skipped. In one embodiment, each query may contain a default response. If the customer does not specify an answer to the query, the default response is used when the survey is submitted.

In the embodiment where customer device 101 is an in-store kiosk, then in a further embodiment, the display of the in-store kiosk shows, for example, a connection indicator, which shows for example, the strength of the network connection to the server, whether the server is down or up; the name of the corporation or restaurant; the date; the time; the number of responding customers; and the name of the manager.

Returning to FIG. 3A, in step 302, the customer completes the survey by, for example, clicking on the submit button or the submit link. The customer is then taken to a summary page. In one embodiment, the customer is asked for his or her contact information in the summary page. In another embodiment, the customer is invited to share the results of the survey on a social networking site, for example, Facebook® or Google® Plus® or Twitter®. In a further embodiment, the customer is invited to log in to these social networking sites by, for example, entering a username and password. In one embodiment, the summary page can contain a thank you message for the customer. In one embodiment, the welcome page is restored after a fixed amount of idle time on the summary page, for example, 3 seconds.

In another embodiment, if the network 107 connection to the server 105 from the customer device 101 is unavailable, the data is stored at the customer device 101 at, for example, a local storage unit such as a hard disk drive, local memory or a flash drive. When the connection is re-established, the locally stored data is submitted to the server 105.

In another embodiment, steps 301 and 302 or parts of 301 and 302 are implemented using voice-based methods. In one embodiment, a customer dials a telephone number from customer device(s) 101 and is presented with a survey by an interactive voice response (IVR) based system. Queries, for example, in the form of questions, and options to respond are presented to the customer by the IVR based system. This requires the customer to supply responses by inputting information using, for example, a phone keypad. In another embodiment, the customer is presented with a survey containing queries by, for example, a customer service representative (CSR) at a call processing facility. Queries, for example, in the form of questions, are presented by a CSR to the customer, and the customer responds to these queries. In yet another embodiment, the customer leaves one or more voice mail messages in response to one or more queries. In another embodiment, one or more phone numbers map to one or more specific responses for one or more queries. For example, the customer may dial 613-546-7BAD (613-546-7223) or 613-546-GOOD (613-546-4003) in response to a query “How was your experience doing business with us today?” The customer completes steps 301 and 302 by, for example, dialing the one or more numbers to respond to the one or more queries. In one embodiment, the one or more queries, the responses and phone number mapping, can be, for example, presented to the customer via a physical banner.

In another embodiment, steps 301 and 302 or parts of 301 and 302 are implemented using SMS-based methods. For example, in one embodiment, a customer is presented with one or more queries in an initial SMS, and one or more options to respond. In one embodiment, the customer responds by, for example, sending a text message containing the customer's one or more responses corresponding to the one or more queries to a generic number, along with a code to identify the customer and/or the particular survey. In another embodiment, the customer responds by sending a text message to a specific number for the survey containing the customer's one or more responses corresponding to the one or more queries. In yet another embodiment, one or more specific SMS numbers map to one or more specific responses for one or more queries. The customer can send one or more messages, even including, for example, one or more blank messages, to the one or more specific SMS numbers. For example, the customer may send an SMS to 613-455-2BAD (613-455-2223) or 613-455-GOOD (613-455-4003) in response to a query “How was your experience doing business with us today?” The one or more SMS messages are registered as responses to the one or more queries. The one or more queries, the responses, and the SMS number mapping can be, for example, presented to the customer via a digital display.

In yet another embodiment, steps 301 and 302 or parts of step 301 and step 302 are implemented using video-based methods. For example, in one embodiment, a customer calls an automated agent or a CSR at a call processing facility using, for example, Skype® video calling. Then, the automated agent or CSR may present one or more queries for the customer. Additionally, the automated agent or CSR may present one or more options corresponding to each query, for the customer to respond to. The customer may then supply either his/her own responses, or a response selected from the options. In another embodiment, step 301 may comprise the customer leaving a private video message. In a further embodiment, step 302 is then completed by the automated agent or CSR on behalf of the customer, or by using the private video the customer left.

In yet another embodiment, steps 301 and 302 or parts of step 301 and step 302 are implemented by making the customer fill out a physical survey form containing one or more queries. Additionally, the form may contain one or more options to respond corresponding to each query. The customer may then supply either his/her own responses or a response selected from the options. The customer can return the survey through a variety of methods. For example, the customer may fax, mail, physically deliver the form, or scan and email the form in.

In another embodiment, steps 301 and 302, or parts of step 301 and 302 are implemented using email-based methods. In one embodiment, a customer is provided with a survey containing one or more queries using an emailed form, and each query contains one or more options to respond. The customer responds to the queries, and submits the survey by emailing the form back in. In one embodiment, the customer may email the form to a generic address and include a code so as to identify the customer and/or the survey. In another embodiment, the customer may email the form to a specific address for the survey. In yet another embodiment, each query and option to respond is sent to the customer in separate emails. In another embodiment, the customer can send one or more emails to one or more specific email addresses which map to specific responses to one or more queries. For example, email address great@businessABC.com maps to a positive response, and poor@businessABC.com maps to a poor response to the query “How was your experience doing business with us today.” The query, the response options, and the email address mapping, can be shown, for example, on a print out. Step 302 is completed as soon as the customer sends an email, and the email is received.

In another embodiment, step 301 and 302, or parts of step 301 and 302 are implemented by the customer requesting for a specific pre-defined webpage. Each specific webpage maps to specific responses to one or more queries. The customer can access the web page by, for example, scanning a 2D bar code, or by using NFC, RFID or Bluetooth or other such communication protocols. The customer can also access the web page by, for example, inputting a URL directly into the web browser on customer device(s) 101.

In another embodiment, steps 301 and 302, or parts of step 301 and 302 are implemented using chat-based methods. In one embodiment, a customer is asked via chat either by an automated agent or by a CSR at a call processing facility one or more queries, and given one or more options to respond. The customer responds to these queries. The CSR or agent may change the queries depending on the responses of the customer. The chat-based methods can be implemented either as part of a website owned by the business or organization; or via a third party chat website.

The customer then enters the post-survey phase 252 of FIG. 3, which covers steps 303-310 of FIG. 3B. In step 303, the customer enters post-survey feedback. During post-survey feedback, a customer has the capability to submit additional comments or feedback as necessary; and also track the “thread” or flow or his or her feedback using several different methods as will be discussed below. Additionally, customers may receive queries from employees and be prompted into submitting additional feedback as a result of receiving queries from employees and responding to these received queries. In one embodiment, routing decisions are made as to which employees the survey feedback should be routed to, and which employees should pose further queries to the customer. In an additional embodiment, a customer may be notified by, for example, notification subsystem(s) 108 of FIG. 1 that queries requiring customer feedback have been sent to the customer. The notification subsystem does so, for example, by using the contact information supplied by the customer.

The customer is notified either in the summary page, or by, for example, notification subsystem(s) 108 of FIG. 1 that he or she can submit additional comments and feedback or track the flow of his or her feedback using, for example, a website at a Uniform Resource Locator (URL). This can be achieved, for example, by using the contact information supplied by the customer. In one embodiment, the customer is automatically redirected to the website after the completion of the initial survey. This website may be generic or specific to the survey or business. In the case of the generic website, the customer may need to enter a pre-supplied reference number to perform additional feedback submission and feedback tracking

Other methods are also possible for a customer to perform additional feedback submission and tracking. For example, in one embodiment the customer performs additional feedback submission and tracking using an “app.” In one embodiment, the app runs on a mobile device running one of Apple® iOS®, Android® or other mobile operating system. In another embodiment, the app runs on a desktop or laptop.

In yet another implementation, a customer performs additional feedback submission and tracking by scanning a 2D bar code, or by using NFC, RFID or Bluetooth or other such communication protocols. The feedback can then be viewed by an employee, who may engage by, for example, supplying comments or answers where necessary.

In yet another implementation, a customer performs additional feedback submission and tracking using SMS. In one implementation, the customer performs additional feedback submission and tracking by sending SMS messages to a generic number. The customer also sends a code or reference number to ensure that the correct feedback flow is retrieved, or to ensure that the submitted additional feedback is added to the correct flow. The customer may enter the code when he or she initially sends the SMS message, or later when prompted. In another implementation, the customer performs additional feedback submission and tracking by sending an SMS message to a specific number which maps to the correct survey and feedback.

In yet another implementation, a customer performs additional feedback submission and tracking using email. The customer can, for example, send comments or answers to queries within the body of the email message. In one embodiment, the customer performs additional feedback submission and tracking by sending email messages to a generic address. The customer also sends a code or reference number to ensure that the correct feedback flow is retrieved, or to ensure that the submitted additional feedback is added to the correct flow. The customer may enter the code when he or she initially sends the email message, or when prompted later. In another implementation, the customer sends email messages to one or more specific addresses connected to the feedback. The specific email addresses may map to specific responses to one or more queries.

In yet another implementation, a customer performs additional feedback submission and tracking using a social networking site such as Twitter®. In one embodiment, the customer does so by entering a microblog update. When the customer enters the microblog update on such a site, in order to perform additional feedback submission and track the flow of his or her feedback, the participant may use an appropriate tag such as “@mention” tag or a hashtag. Then the right feedback is retrieved or the microblog update is entered into the correct flow. In a similar manner, a customer may perform additional feedback submission and track the flow of his or her feedback from a site such as Yelp® or TripAdvisor® by adding a question in a post, and then using the appropriate tag.

In yet another implementation, a customer performs additional feedback submission and tracks the flow of his or her feedback from a chat program on a desktop or on a website, examples of which have been given previously.

In yet another implementation, a customer performs additional feedback submission and tracks the flow of his or her feedback by calling a provided phone number. In one implementation the phone number is generic. Then the customer dials in a reference number when, for example, prompted by an interactive voice response system to ensure that the correct feedback flow is retrieved, or to ensure that the submitted additional feedback is added to the correct flow. In another implementation the phone number is specific to a particular feedback flow. The customer can then enter a comment verbally, which may be further converted to text using a speech-to-text system. In another embodiment, the customer speaks to an operator who adds the message to the feedback flow.

In step 304, the feedback from the initial survey phase and post-survey feedback is routed to employees, by, for example, feedback processing system 122 communicating with employee devices 111. As part of the routing process, decisions are made as to which employees the feedback should be routed to. The routing can be performed based on predefined criteria, or by using heuristic and machine learning to optimize the processing workflow associated with the feedback. Furthermore, routing may also take place during or before the post-survey feedback. In one embodiment, as mentioned previously, routing takes place at the start of the post-survey feedback. Then, employees to whom the feedback from the survey phase is routed, submit additional queries to the customer to prompt additional feedback during the post-survey feedback. In another embodiment, routing is also integrated into the post-survey feedback. Then, as customer feedback is obtained, the employees to whom the feedback is routed to may change. In yet another embodiment, routing is performed before, during and after the post-survey feedback.

In step 305, in one embodiment, one or more of the employees performs the step of triaging the feedback using an employee device 111 by communicating, for example, with feedback processing system 122. In a further embodiment, the one or more employees sort one or more pieces of feedback into one or more groups. Then the triaging is performed on the one or more groups. In another embodiment, the feedback is automatically triaged by the processing system 122. In a further embodiment, each piece of feedback is put into a pre-defined or custom workflow.

In one embodiment, the feedback provided in the survey and post-survey feedback affects the choice and configuration of the workflow of the entire customer engagement process. For example, the workflow can change depending on whether the overall survey and post-survey result is deemed positive or negative, and if it is negative, whether the information revealed in the survey and post-survey is actionable or not actionable. For example, if the survey and post-survey were deemed positive, the workflow used may comprise a simple response wherein the customer is thanked appropriately. If the survey and post-survey feedback were deemed negative and the information obtained during the survey and post-survey were deemed actionable, the workflow may comprise sending an additional query to the customer, in the form of a question asking the customer about specific areas for improvement. If the survey and post-survey were deemed negative and information obtained was not actionable, the workflow may comprise sending a response with an apology about the issue, and may additionally comprise sending a coupon or a credit to the customer. Other types of messages are also possible. For example, if the customer has supplied suggestions for specific areas of improvement, the workflow may comprise a resolution taking into account the customer's suggestions and a query comprising a question about how well the company addressed the customer's issue.

A sample workflow is described in steps 306-310 as shown in FIG. 3B. In step 306, employees make comments that are attached to the feedback and create one or more tasks based on the triaged feedback. For example, if feedback shows the customer is not happy with the facility due to ‘dirty bathroom’, the employee can create a cleaning task that's associated with the feedback. Employees can also associate feedback with existing tasks or known issues, such that when the existing tasks or known issues are fixed, all of the customers who initiated similar feedback can receive updates, responses, or further queries at the same time.

In step 307, an employee with the permission to reply to the customer sends a reply to the customer. Examples of replies include sending a comment to the customer and asking further queries. In one embodiment, the reply additionally comprises marking the overall survey and feedback as resolved.

In step 308, the customer is notified of the reply, by, for example, notification subsystem(s) 108 of FIG. 1 using the previously supplied contact information.

In optional step 309, the customer provides additional comments, or answers the follow up questions.

In step 310, a determination is made about whether the engagement process, (including, for example, the issue, survey, feedback, additional info) has been resolved.

If yes, then the engagement process enters the closure phase (step 253 of FIG. 3). In one embodiment, as shown in step 311 of FIG. 3B, during the closure phase, the process is deemed closed and the customer is notified. If no, then steps 306 to 310 are repeated until the engagement process is deemed closed.

In one embodiment, step 311 is performed by, for example, feedback processing system 122, after a set time period.

In one embodiment, the closure phase may include a final question to the customer about how well his/her feedback and survey were handled. In yet another embodiment, the closure phase includes one or more questions to the customer asking about the likelihood that he/she would recommend the business to other people. In another embodiment, the customer can create a new survey and reference the existing survey and feedback during the closure phase.

In one embodiment, survey results, post-survey results and other customer feedback during these phases, including comments and questions are collected in real time by the feedback collection system(s) 121 of FIG. 2. The feedback collection system(s) 121 stores results in the database 106, and additionally passes information to feedback processing system(s) 122. Feedback processing system(s) 122 performs processing of the results stored in the database 106, in conjunction with feedback collection system(s) 121 and analytic system(s) 123. Feedback processing system(s) 122 additionally communicates with employee device(s) 111 which form part of internal system(s) 110.

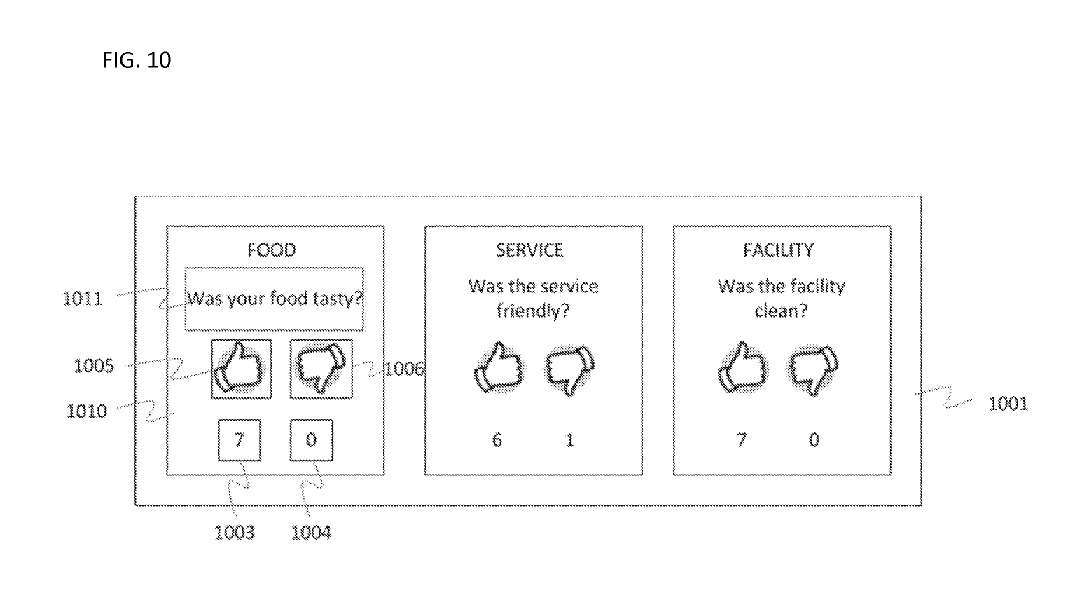

Then, one or more views such as scoreboards or dashboards related to the specific surveys are updated in real-time. For example, FIG. 10 shows a scoreboard which has been updated in real-time. For example, for food category 1010 with question 1011 “Was your food tasty” the score 1002 shows the tallies 1003 and 1004 for the “yes” votes as represented by the “thumbs up” icon 1005 and “no” votes as represented by the “thumbs down” icon 1006 respectively. In one embodiment, one or more of these scores are updated in real-time, as customer feedback is submitted from input devices.

In another embodiment, the scoreboards or dashboards are displayed on display unit(s) 109. In this embodiment, in addition to the questions and scores, other data is shown on the scoreboards. These include, for example, a connection indicator, which shows for example, the strength of the network connection, whether the server is down or up; the name of the corporation or restaurant; the date; the time; the number of responding customers; and the name of the manager.

In another embodiment, results for several different stores within a region are aggregated and shown on a scoreboard or a dashboard on one or more of the display unit(s) 109, for example, for a regional manager. The region could be a county, district, province, state, national area comprising several states such as, for example, the United States Southwest, a country, a continent or an area of a continent such as, for example, North America, South-East Asia and so on. In yet another embodiment, the aggregation is done by business lines, product lines, and business functions that may or may not be correlated to geographical regions.

In a further embodiment, the analytic system(s) 123 generates summary statistics for given periods, for example hourly, daily, weekly, monthly and annually based on the inputs provided by the customer. Then, customer feedback can be viewed and used to track short-term and long-term employee performances, store performances, and product performances. In one embodiment, email digests of these summary statistics are sent out to relevant people, and in another embodiment, reports are sent to upper management. In yet another embodiment, the one or more results are sent to performance evaluation subsystems. In yet another embodiment, these summary statistics are displayed on one or more of the display unit(s) 109 along with the scoreboards and dashboards.

In a further embodiment, one or more ratings can be assigned by the customer during the closure phase using one or more customer devices 101. This closure rating shows how satisfied the customer is with respect to the overall engagement process. Generally speaking, the customer is more satisfied and gives a higher rating when his survey responses are properly addressed, and less satisfied and gives a lower rating when the issues brought up in his survey responses are left mostly unnoticed with no actions taken.

In a further embodiment, one or more ratings can be assigned at the beginning of the workflow, for example during the post-survey feedback, or the initial survey phase. The comparison of the pre-engagement rating and post-engagement rating shows the effectiveness of the real-time customer engagement system at, for example, the store level, region level, etc. For example, if a significant increase in ratings between pre-engagement and post-engagement, and hence an improvement in customer satisfaction, is observed, managers can be confident that the correct processes have been implemented.

In yet another embodiment, the system may additionally comprise methods to handle exceptions. Exceptions may arise if, for example, specific answers to certain questions are supplied. In another embodiment, an exception could arise depending on the type of the customer that initiated the survey. The information on the type of customer can be drawn from, for example, the social networking site that the customer elected to share the results of the survey on. For example, an exception may arise if a customer who has more than 1000 followers on Twitter creates a survey. In another embodiment, an exception arises if the number of surveys is above or below one or more thresholds for a given time period. For example, an exception may arise if the number of surveys is above a threshold, as this is an indication that there are major issues in the business operations. An exception may arise if the number of surveys is below a threshold, as the system receiving survey results may be offline. In another example, there may be a lower and upper threshold, and an exception may also arise if the number of surveys is either above the upper threshold or below the lower threshold. In another embodiment the exception handling process is part of the triage process performed in step 305 of FIG. 3A, and exceptional results are prioritized higher than other feedback results. In yet another embodiment, exceptions are used to prompt escalations or emergency responses.

In a further embodiment, once the survey phase is completed, a loop is initiated as part of the customer engagement process. The initiation of loops is discussed in detail in the US patent application titled “System And Method For Rule-Based Information Routing and Participation,” assigned Ser. No. 13/728,240, filed Dec. 27, 2012 to Richardson and herein incorporated by reference as if reproduced in its entirety; and in the US patent application titled “System And Method For Rule-Based Information Routing and Participation,” assigned Ser. No. 13/791,482, filed Mar. 8, 2013 to Richardson and herein incorporated by reference as if reproduced in its entirety. In one embodiment, the loop is initiated and managed by a separate system, such as the implementation system detailed in the section titled “The Implementation System” in the US patent application “System And Method For Rule-Based Information Routing and Participation”, assigned Ser. No. 13/728,240, filed Dec. 27, 2012 to Richardson. In another embodiment, the loop is initiated and managed by the system of FIG. 1.

In one embodiment, the post-survey phase 252 of FIG. 3 comprising post-survey feedback, routing and triaging; and closure phase 253 of FIG. 3 are implemented as part of a system to engage with the initiated loop, as discussed in the US patent application titled “System And Method For Rule-Based Information Routing and Participation,” assigned Ser. No. 13/791,482, filed Mar. 8, 2013 to Richardson.

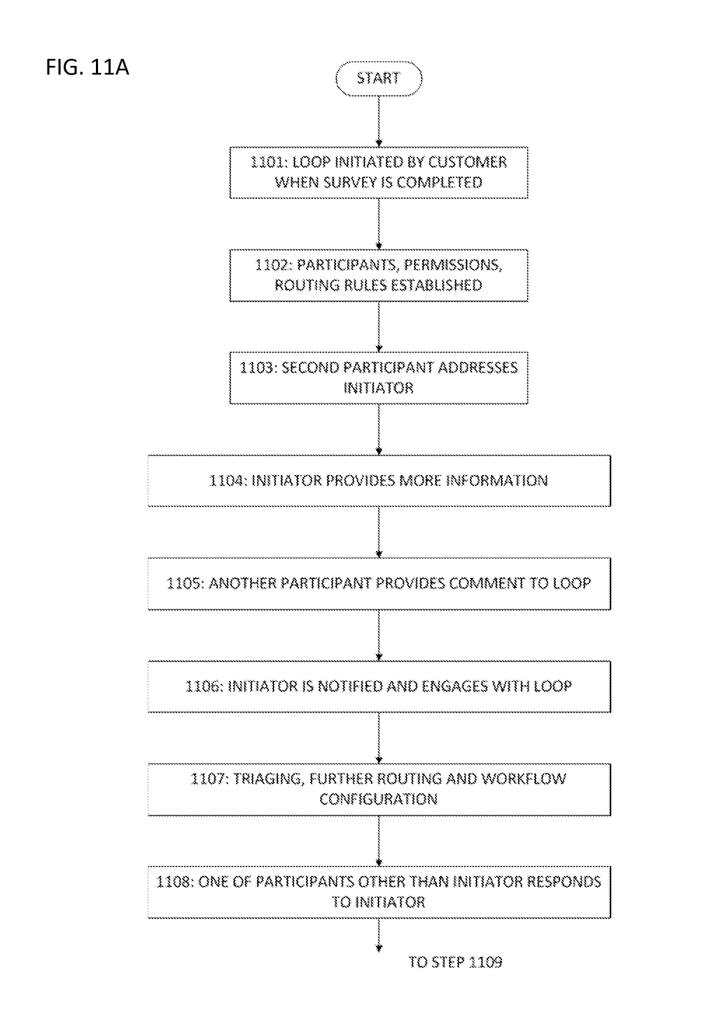

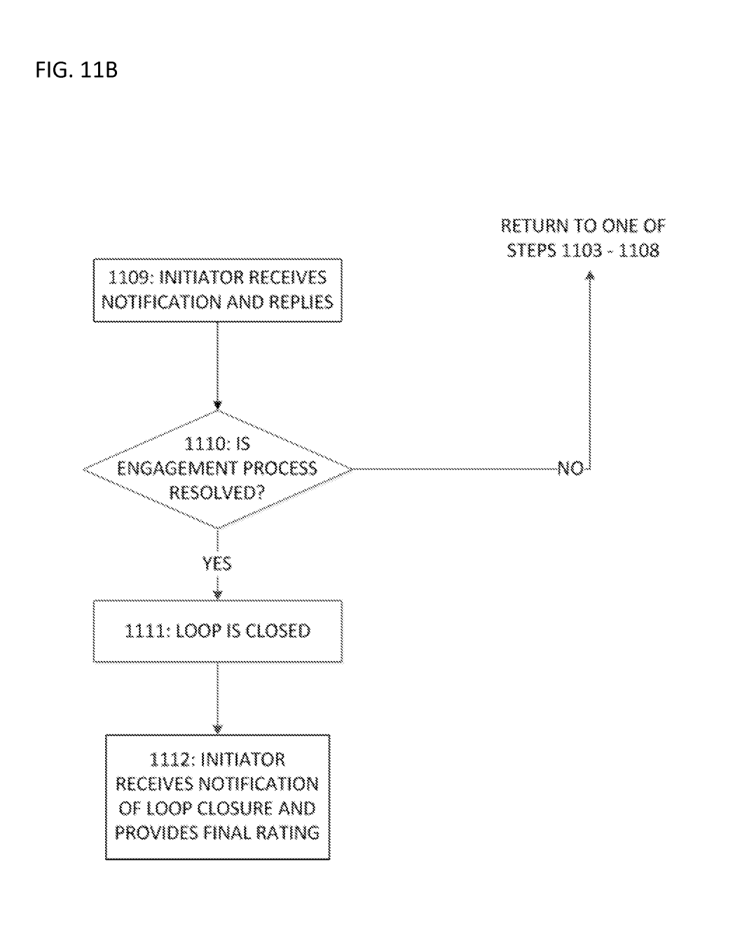

An example is shown of implementing post-survey feedback as part of a loop engagement flow by a participant is shown in FIGS. 11A and 11B. In step 1101, the loop is initiated by the customer once the survey is completed and the system has entered post-survey phase 252 of FIG. 3. The customer now becomes the initiator.

As explained before, there are embodiments wherein routing takes place before the start of the post-survey feedback. In one embodiment, as part of the routing process, participants and participant visibility is then determined in step 1102. Methods to determine participant visibility are explained in the section titled “Derivation of Attributes, Determination of Visibility, Routing Rules, Participants” in the US patent application “System And Method For Rule-Based Information Routing and Participation”, assigned Ser. No. 13/728,240, filed Dec. 27, 2012 to Richardson. In U.S. patent application Ser. No. 13/728,240 participants who follow attributes which satisfy one or more routing rules of a loop and have the appropriate permissions are determined to be followers of a loop. As explained in U.S. patent application Ser. No. 13/728,240, the followers of a loop may change during the lifetime of a loop.

In step 1103, as part of the post-survey feedback, a second participant such as a staff member then addresses the initiator by using, for example, the email address or other contact info supplied by the initiator. Additionally, the staff member may supply a link to a website containing further queries, to prompt additional feedback from the customer. In addition, the website may also notify the initiator of how he or she should track his or her feedback. In step 1104, the initiator provides more information by, for example, using the link mentioned in step 1103.

In step 1105, another participant, different from the second participant provides a comment to the loop. In step 1106, the initiator is notified of this comment via, for example, SMS messaging, and engages with the loop by, for example, sending an SMS message to a specific number.

In step 1107, triaging and further routing is performed, then the workflow is appropriately configured based on the feedback obtained during the post-survey feedback, and the triaging and further routing. During this step, participants engage in further discussion but exclude the initiator by using the appropriate permissions for the messages which form part of the discussion.

In step 1108, one of the participants other than the initiator sends a response specific to the loop by, for example, email. In step 1109, the initiator then receives notification of the update by, for example, email, and sends a reply by, for example, email to a specific email address connected to the loop. In step 1110, the participants determine whether the engagement process, (including, for example, the issue, survey, feedback, additional info) has been resolved.

If yes, then the process enters the closure phase (step 253 of FIG. 3). In step 1111, the loop is closed. In step 1112 the initiator receives notification of the closure of the loop, and can choose to provide a final rating on the outcome of the interaction using, for example, a website interface. If no, then the process returns to one of steps 1103 to 1108 of FIG. 11A

In yet another embodiment, the system which manages the one or more loops sends data on the loops to the server 105 or feedback processing system 122 or analytic system 123, or to the database to be retrieved by the server 105, or feedback processing system 122 or analytic system 123. Then, for example, the server or analytic system 123 or feedback processing system 122 can use this data to produce further results and performance statistics. For example, statistics such as mean time that a loop is open and variance of time that a loop is open can be combined with the further results and performance statistics produced. As another example, the number of loops generated during different periods can be compared against results of surveys submitted by customers to obtain actionable insights on performance. All of this information can be sent as part of the email digests and management reports, as well as displayed in the display unit(s) 109.

In a further embodiment, whenever an employee responds to a customer, the response is sent to other employees who were chosen during the routing process. In another embodiment, an employee can choose to respond to groups of customers who share a similar issue or similar survey responses, or customers with within similar demographic, or any (arbitrary) groups of customers and employees deemed relevant for the communication.

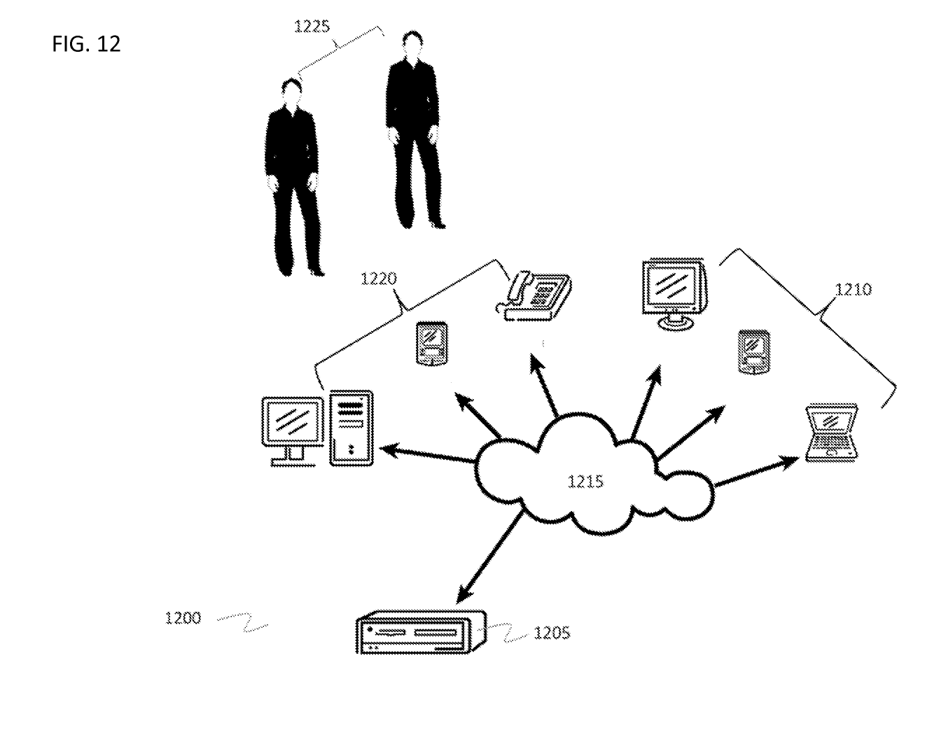

In one embodiment, responses are sent to other employees and customers using one or more Mass Notification System (MNS) 1200 such as shown in FIG. 12. The MNS 1200 is discussed in detail in the US patent application titled “Method and System and Apparatus for Mass Notification and Instructions to Computing Devices,” assigned Ser. No. 12/887,135, filed Sep. 21, 2010 and herein incorporated by reference as if reproduced in its entirety.

FIG. 12 depicts a Mass Notification System (MNS) 1200 connected to a plurality of computing devices 1200 via a network 1215. In one embodiment, the MNS 1200 may itself be part of enterprise system 100, server(s) 105 or notification subsystem(s) 108 in FIG. 1. In one embodiment, network 1215 is part of network 107 of FIG. 1. Generally, the computing devices 1210 can be a Personal Computer (PC), laptop, terminal connected to a server, dumb terminal, tablet computer, PDA, Internet Protocol phone, smart phone or any other device capable of displaying information and/or outputting audio. In another embodiment, computing devices 1210 include customer devices 101, employee devices 111, display unit(s) 109 and system(s) 102 of FIG. 2. The MNS 1200 uses an MNS server 1205 which provides the ability to send out notifications in the form of text, image, video, audio, and/or interactive components to a selected group of computing devices 1210, by, for example, interacting with notification subsystem(s) 108 of FIG. 1. As well, these notifications can initiate the execution or launching of specific applications or instructions on the various computing devices which present the notifications to the customers. Notifications of one or more levels of priority can be sent by the MNS.

In one embodiment, the MNS server 1205 receives input data, such as, for example, a participant response to an initiator from at least one of a plurality of administrator devices 1220 to which it is connected by the network 1215. Once the input data is received from the administrator devices 1220, the MNS server 1205 determines which selected employees and customers are to receive the notification and, thereby, which computing devices are to be contacted. For each computing device to be contacted, suitable notification data is constructed so that the notification can be presented to the customer of that computing device. The notification data containing the notification in the chosen format or combination of formats (e.g. text, image, audio, video, and/or interactive components) is then broadcasted to a selected group of computing devices 1210. It should be noted that notification data may include text, image, audio, video, and/or interactive components to be presented to the customer being notified. The notification data may also include data to be interpreted as commands or requests by the computing devices 1210.

The administrator devices 1220 are used by the administrators 1225 to configure and use the MNS. For this embodiment, administrative devices can be a PC, laptop, terminal connected to server, dumb terminal, tablet computer, smart phone, PDA, IP phone, phone, gateway or any other device capable of inputting, displaying and/or playing back information.

It should be noted that a member of administrators 1225 can be a person, a program, or a system that can initiate and manage notifications. Administrators 1225 may be, for example, the administrators of enterprise system 100 of FIG. 1.

It should also be noted that notifications received by the computing device 1210 from MNS server 1205 can originate from any administrator device 1220. For example, notifications can originate from a telephone using dial-in capability, a mobile electronic device through a browser, personal computer using a browser or a dedicated program, or another system, appliance or application that is connected to trigger notifications on the MNS server 1205 through a gateway.

In one embodiment, the MNS server 1205 is implemented within enterprise system 100 of FIG. 1, and interacts with the other components of enterprise system 100 such as notification system(s) 108, server(s) 105 and database 106, so as to perform the functions outlined above. In another embodiment, the MNS server 1205 is implemented within server(s) 105.

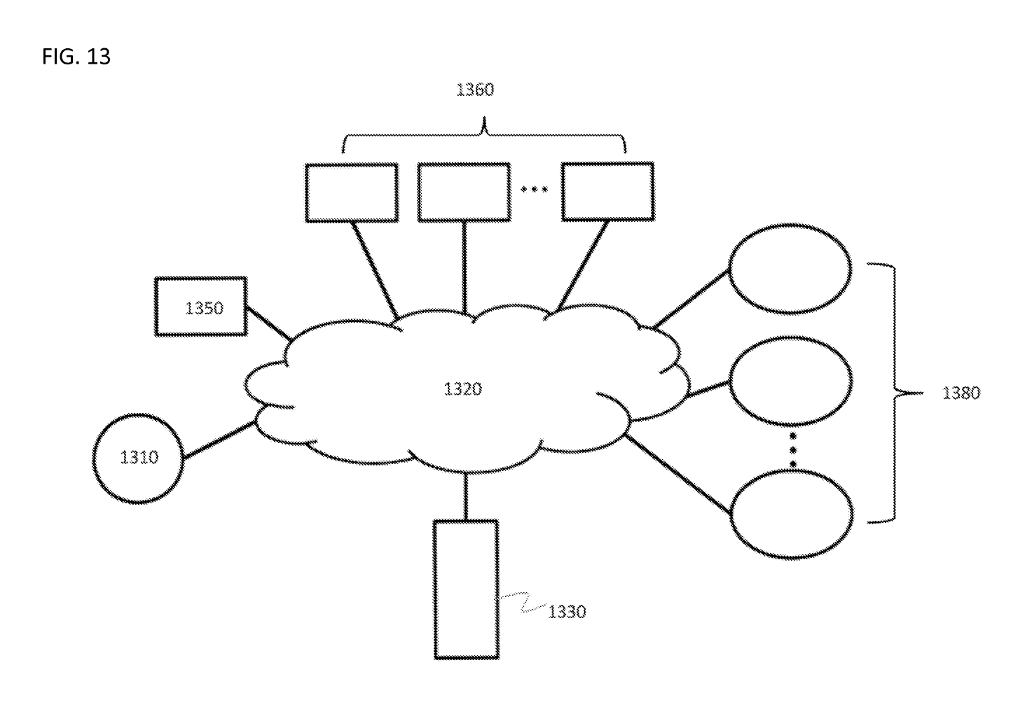

In another embodiment, responses are sent to other employees and customers using an Intelligent Enterprise Notification Server (IENS) 1330, as shown in FIG. 13. The IENS 1330 is discussed in detail in the US patent application titled “Notification System,” assigned Ser. No. 13/268,141; filed Oct. 7, 2011 and herein incorporated by reference as if reproduced in its entirety.

An IENS is deployed as network element 1330, for example, as part of the network. In one embodiment, the IENS 1330 may itself be part of enterprise system 100, server(s) 105 or notification subsystem(s) 108 in FIG. 1. The IENS 1330 interfaces with the network 1320 to interface with the client device 1310. In one embodiment, network 1320 is part of network 107 of FIG. 1 The client device 1310 represents any entity which can signal the IENS 1330 to perform an enterprise function. This may also include customer device(s) 101, display unit(s) 109 and employee devices 111. In this embodiment, the client device 1310 can be, for example, a device used by the participant to respond to the customer, such as a cell phone using SMS, a smartphone using an application or browser-based application, a traditional telephone using regular calling, or an internal or external computer using a machine interface such as Hypertext Transfer Protocol (HTTP), Session Initiation Protocol (SIP), Simple Object Access Protocol (SOAP) or a similar mechanism.

The network 1320 provides connectivity between the client devices 1310 and the IENS 1330 such that reasonable communication between the client devices 1310 and the IENS 1330 is supported. Once the IENS 1330 receives a client request, which could be, for example, a request to notify other employees of a response to a customer, originating from a client device, the IENS 1330 ensures that the request is valid. The IENS 1330 then interacts with peer Enterprise Application Servers 1360 through the network 1320 to complete the request. The business logic of how the request is handled can be resident on the IENS 1330 and/or the Enterprise Application Servers 1360. This logic is programmed into the IENS 1330 and the Enterprise Application Servers 1360 through the Enterprise Administration Server 1350. In one embodiment, Enterprise Application Servers 1360 and Enterprise Administration Server 1350 are part of server(s) 105 of FIG. 1.

Once the request is complete, the result is returned to the IENS 1330. This can result in two activities—a response to the client device and a notification to a target device. The response to the client device is provided if required. The client request can also generate a notification to the target devices 1380, which in this case may be the employee devices 111, customer device(s) 101, or display unit(s) 109, through the network 1320. A notification is one or more sets of messages which need to be communicated to a target audience based upon the result of the client request. How the result is handled is identified by the policy set by the Enterprise Administration Server 1350. Following notification to the target devices 1380 through the network 1320, client acknowledgements or other responses may be received by the IENS 1330 through the network 1320.

In a further embodiment, responses are sent to other employees and customers through a routing module, such as that described in detail in the US patent application titled “Managed Brand Feedback System”, assigned Ser. No. 13/332,481; filed Dec. 21, 2011 and herein incorporated by reference as if reproduced in its entirety.

Such a routing module is, for example, part of enterprise system 100, server(s) 105 or notification subsystem(s) 108 in FIG. 1. Then, the routing module may, for example, upon instructions by the employee who responded to the customer, distribute the response or a notification of the response to one or more of the other employees or customers.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system to enable real-time engagement with one or more customers utilizing one or more customer devices, implemented using one or more servers, said servers connected to said customer devices over at least one network, comprising:
a survey phase, wherein one of the one or more customers utilizes the one or more customer devices to send feedback to one of the one or more servers over the at least one network;
a post-survey phase, wherein the one of the one or more customers utilizes the one or more customer devices to send feedback to one of the one or more servers over the one or more networks; and
a closure phase.

2. The system of claim 1, further comprising one or more internal systems, said one or more internal systems further comprising
one or more employee devices, said employee devices coupled to each other, the one or more servers and one or more customer devices over the one or more networks, and
one or more display units.

3. The system of claim 2, wherein said one or more employee devices, said one or more display units and said one or more customer devices are communicatively coupled to each other by one of
an intelligent enterprise network system (IENS);
a mass notification system (MNS); and
a routing module.

4. The system of claim 2 further comprising routing at least one of survey and post-survey feedback to at least one of the one or more employee devices.

5. The system of claim 2, further comprising updating information on at least one of the one or more display units based on at least one of the received survey and post-survey feedback.

6. The system of claim 5, wherein said updating information comprises updating a scoreboard on at least one of the one or more display units.

7. The system of claim 2, wherein the post-survey phase further comprises triaging at least one of the received survey and post-survey feedback.

8. The system of claim 7, wherein said triaging is performed either automatically or manually.

9. The system of claim 8, further comprising a real-time engagement workflow, wherein said workflow is based on the triaging.

10. The system of claim 1, wherein at least one of the received survey and post-survey feedback is used to perform at least one of tracking or evaluating performance.

11. A method to enable real-time engagement with one or more customers utilizing one or more devices, implemented using one or more servers, said servers connected to said devices over at least one network, said method comprising:
performing a survey phase comprising
receiving submitted feedback from one of the one or more customers, said feedback submitted by the one of the one or more customers using the one or more customer devices;
performing a post-survey phase comprising
receiving submitted feedback from one of the one or more customers submitted using the one or more customer devices; and
performing a closure phase.

12. The method of claim 11, further comprising one or more internal systems, said one or more internal systems further comprising
one or more employee devices, said employee devices coupled to each other, the one or more servers and one or more customer devices over the one or more networks, and
one or more display units.

13. The method of claim 12, wherein said employee devices, said display units and said one or more customer devices are communicatively coupled to each other by one of
an intelligent enterprise network system (IENS);
a mass notification system (MNS); and
a routing module.

14. The method of claim 12 wherein performing the post-survey phase further comprises routing at least one of survey and post-survey feedback to at least one of the one or more employee devices.

15. The method of claim 12, further comprising updating information on at least one of the one or more display units based on at least one of the received survey and post-survey feedback.

16. The method of claim 15, wherein said updating information comprises updating a scoreboard on at least one of the one or more display units.

17. The method of claim 12, wherein performing the post-survey phase further comprises triaging at least one of the received survey and post-survey feedback.

18. The method of claim 17, wherein said triaging is performed either automatically or manually.

19. The method of claim 18, further comprising a real-time engagement workflow, wherein said workflow is based on the triaging.

20. The method of claim 11, wherein at least one of the received survey and post-survey feedback is used to perform at least one of tracking or evaluating performance.
